(19) United States
(12) Patent Application Publication
(10) Pub. No.: US 2012/0230366 A1
(43) Pub. Date: Sep. 13, 2012

(54) Optical Digital Thermometer

(76) Inventors: Yaosheng Chen, Blacksburg, VA (US); Fajian Zhang, Blacksburg, VA (US); Qiao Chen, Blacksburg, VA (US)

(21) Appl. No.: 13/044,645

(22) Filed: Mar. 10, 2011

(51) Int. Cl. G01K 7/00

(52) U.S. Cl. 374/170; 374/E07.001

(57) ABSTRACT

The present invention is an optical digital thermometer, the novel non-contact digital optical thermometer is based on quantum theory of lightwaves, it can replace the conventional non-contact thermometers that are based on Planck's Law of Blackbody Radiation. The said invention points out four aspects of misunderstandings regarding relationship between temperature (thermal energy) and wave energy of a subject emulated by Boltzmann, Wien, Planck, Rayleigh, Hopkins and other scientists 130 years ago, namely:
(1) the temperature of an object is not evenly distributed;
(2) lack the awareness of logarithmic distribution of the energy;
(3) the fact that a sensor (a thermocouple) has a limited operation range was ignored;
(4) treated variable as a constant, in fact, the Planck constant of a materials is not a true constant.

These errors result in incorrect temperature measurements, and causes huge waste of energy and technology failures. This invention indicates that in Electromagnetic waves, the law of energy distribution and measurement of discrete and consecutive quantum energy. Based on these, non-contact thermometers with various levels of precision can be made. It can also be achieved material and distance irrelevant point temperature measurement. This is a revolution of temperature measurement technology.

### FIELD OF INVENTION

The present invention relates to an optical digital thermometer (referred to as DT), which belongs to the areas of quantum optics and photonics technology. More particularly, the invention relates to achieving digital processing of optical signal by reducing the transmission speed of a high-speed quantum waves, in this way, accurate measurement of temperature can be implemented.

### BACKGROUND OF THE INVENTION

The present invention is an optical digital thermometer, which is based on the innovation of digital optics: high-speed quantum waves that carry temperature information are slowed down so that individual quantum can be distinguished easily via common electro-optic devices. The said thermometer can replace traditional non-contact thermometers based on Planck's Law of Blackbody Radiation and other theories established by Stefan Boltzmann, Wien, Rayleigh, Hopkins, Planck and other scientists, which describe relationships between temperature and radiation and are problematic in 4 aspects:
(1) the temperature of an object is not evenly distributed;
(2) lack the awareness of logarithmic distribution of the energy;
(3) the fact that a sensor (a thermocouple) has a limited operation range was ignored;
(4) treated variable as a constant, in fact, the Planck constant of a materials is not a true constant.

Stefan and Boltzmann published their research result on the relationship between thermal radiation and temperature in 1879 and 1884, respectively. The foundations of statistical thermodynamics were laid down in the late 1800s by those such as Maxwell, Boltzmann, Max Plank, Clausius, and Josiah Willard Gibbs. Nobel laureate Wien's displacement law states that the wavelength distribution of thermal radiation from a black body at any temperature has essentially the same shape as the distribution at any other temperature, except that each wavelength is displaced. Rayleigh Jean's Law, published in 1900, stated that radiation energy increases with electromagnetic frequency proportionally, but Rayleigh and Jeans did not realize the logarithmic growth law of energy on frequency. Planck completed his blackbody radiation experiment in 1900, his Law of Blackbody Radiation was published in 1901, Planck's theory made implicit use of the light quantum hypothesis.

They all, in the historical context, have made great contributions in temperature measurement, but in the field of non-contact temperature measurement, use of said theories for quantization correction of non-standard blackbody radiation can not achieve precision measurement. In fact the temperature difference between edge and center of a surface of a standard blackbody calibration furnace is 1-4° C., and because the radiation coefficient of a material is not a constant, as a example, at the same condition, temperature difference of shiny and rough aluminum surfaces measured by traditional non-contact infrared thermometer can be as high as 100° C., temperature measurement in this way leads to a qualitative and vague result, therefore for actuate temperature measurement the said laws must be abandoned.

To this end, based on our long-term experiments and theoretical analysis, the present invention proposes a “distribution and measurement rule of discrete quantum and consecutive quantum energy”, which concludes the following formula:

E=LnT=γh=mb=NB (1)

This formula indicates that at temperature T, where T is Kelvin scale, the spontaneous radiation of energy E can be expressed by the length of the quantum line, which equals the natural logarithm of temperature. When all quantums are aligned in sequence order, thermal radiations emit not only quantum wave, but also electro-magnetic wave, the corresponding quantum line length equals to the wave number of electromagnetic wave N; which equals the product of distances between their basic units (h, b, B). Therefore, the above formula can achieve non-contact temperature measurement of a point, with a variety of different levels of precision, the measurement results have nothing to do with the size of the measured object, the measurement distance, and material properties (the surface emissivity). This is a revolution in temperature measurement technology.

### BRIEF DESCRIPTION DRAWING

FIG. 1 is a diagrammatic representation of optical digital thermometer, the divergent spherical wave emitted from the surface point is converged by spherical lens 1 to the center of back focal plane of the lens, which just lands on the end of a pick-up fiber 3, point temperature measurement is ensured by pick-up fiber 3 and wave detector 2, another fiber in fiber 3 launches a low-speed quantum wave NB. Optical A/D converter 4 comprises photodiode 5, pre-amplifier 6, LED 7—launching wave NB—and crystal oscillators 8. Output from pre-amplifier is counted and calculated by microprocessor 9 to get digital temperature signal OUT I, it can also be converted to analog signal as OUT II through D/A converter 10, results are displayed on the monitor 11, as long as menu set buttons 12 and monitor 11 are set, various extended functions can be implemented by microprocessor 9.

FIG. 2 is another configuration of digital optical thermometer, where the output pulse with spacing B of laser 14 is modulated by crystal oscillator 13, the pulse transmits through a half-transparent mirror 15 to reach the target point, temperature information of the point is then carried on the probe pulse beam, and transmit again through mirror 15, detected by photodiode 16, followed by pre-amplifying and processing, the corresponding temperature can be determined, also, various extended functions can be implemented by microprocessor 9.

FIG. 3 is a detailed description of the relationship between temperature (heat) and spontaneous radiation energy (quantum energy), and the computation and distribution rule of quantum and quantum energy.

### DETAILED DESCRIPTION

The present invention is an optical digital thermometer. According to the proposed quantum and quantum energy distribution and measurement rule, for an electromagnetic waves with frequency γ and wave number m=1/λ means “quantum”, it is essentially discrete, but quantum energy is consecutive. Photons, electrons, and other basic particles can be unified in the quantum theory, referred as the quantum wave. In the process of information transmitting and receiving, digital technology is identical to quantum technology. Quantum energy is the spacing of adjacent quantums, it is consecutive, on the other hand, quantum and quantum energy have synchronic distributions and in logarithmic order, within the “ordered” limit, the product of quantum number and the quantum energy is the total energy E. Temperature (heat) of a point at the surface of a object and the corresponding wave energy of spontaneous emission (quantum energy) of that point raise with increasing temperature, but the increasing rate is slow down, until saturation is reached, that is to say the “ordered states” ends. This is what we call the logarithmic distribution, it can be mathematically expressed in following formulas:

E=LgT or LnT (2-A)

E=γh=mb=NB (2-B)

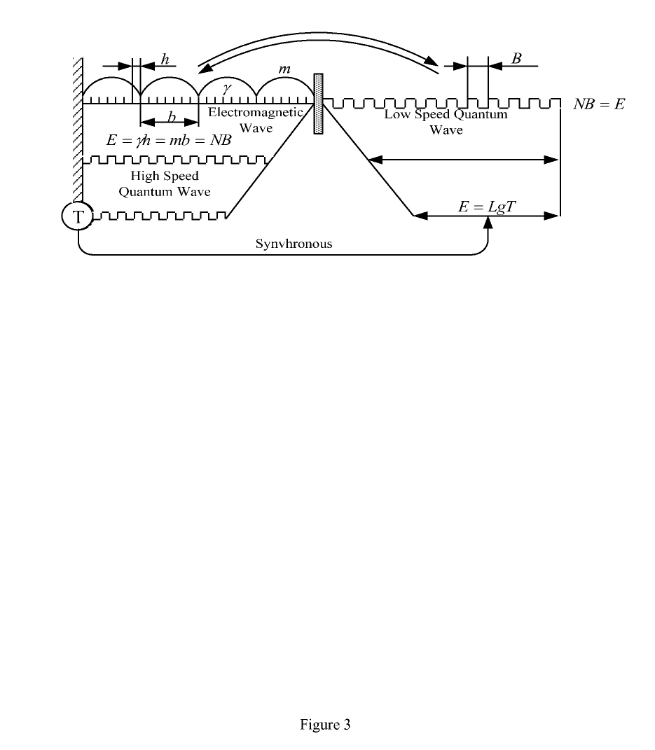

Based on these formulas, at temperature T, heat energy equals to wave energy, the length of quantum line equals to the product of quantum number and quantum spacing, it is a orderly arranged straight line, as shown in (2-B), its length can be measured using (2-A) as reference ruler, the scale of the ruler is determined by the base of adapted logarithm, natural logarithm and Kelvin scale are used in (2-A), when converting high-speed quantum wave NB into a low-speed quantum wave mb, selection of proper electronic components is important to have B distinguishable. For temperature T, as long as T>0, Celsius, Fahrenheit, or Kelvin scales can be adapted. For better measurement precision, more quantum numbers within a certain length is desired. In formula (2-B) γ is frequency, h is the distance between adjacent oscillators, m is wave number, b is the spacing between adjacent wave numbers, (it is actually the length of a wave number); temperature T and energy distribution change with N, γ and m, but N has low transmission speed, it can be distinguished by existing optical components, based on these, it is easy to get the distance between the two quantums, or B=LgT/N, or B=LnT/N, where B is enlarged by n. when the true temperature T is found, it should be decreased by n times, as shown in FIG. 3.

Based on formulas (1) and (2), non-contact thermometer with varying precision levels can be made. As long as the scale of the ruler has been set as lgT, in order to improve the measurement accuracy, one must increase the code number N to shorten the distance B. With the improved accuracy, the said thermometer can be used as standard calibration instrument to achieve a revolution in temperature measurement technology. As well known, for standard platinum-rhodium thermocouple, the joint-point of two metal lines is the sensitive part of the thermoelectric effect, with the surface temperature measured in the range of 300° C.-1450° C. the measured temperature is correct, because the point temperature measurement is independent of the material property and size, the measurement distance is zero, when the temperature variation is slow and can be treated as quasi-static condition, the measurement accuracy is so high that it can be used as a temperature measurement standard. However, under high temperature and dynamic conditions, thermocouples are not competent, the response is very slow, and a lot of precious metals are consumed, therefore non-contact temperature measurement technology is a demanding technology Using concept of quantum length for temperature measurement is both accurate and convenient, the key technology is to reduce the transmission velocity of quantum wave.

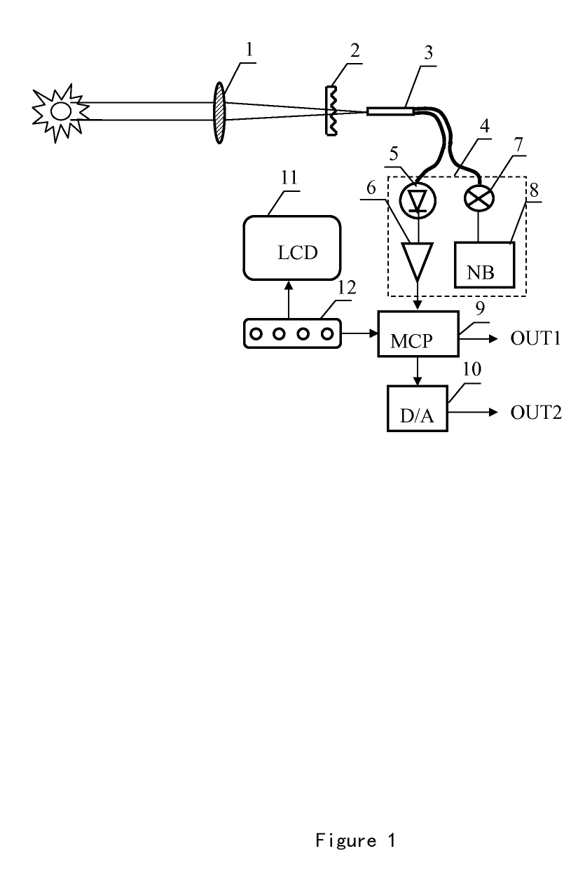

An optical digital thermometer is shown in FIG. 1, it utilizes hybrid indirect and direct approaches to decelerate quantum waves, which are associated with temperatures and are carried by electromagnetic waves. During temperature measurement, the waves first transmit through spherical lens 1 at high-speed, then reach wave detector 2, where the useless information is excluded due to the diffraction effect of wave detector, this further reduce the size of optical spot, which focuses on one end of a fiber, while the other fiber lunches a low speed quantum wave NB to carry the high-speed electromagnetic waves exiting from wave detector, photo detector detects the signals, counts the number N. by utilizing pre-amplifier 6, to distinguish each quantum N, as B is known, so in the microprocessor lgT=NB=mb can be calculated easily and finally temperature T=10^{NB} is then concluded.

Larger effective diameter of spherical lens shown in FIG. 1 provides greater non-contact measurement distance, by using this lens, divergent spherical waves are converged right at the end plane of fiber 3, combining with detector 2, point temperature measurements is ensured. Wave detector is a two-dimensional diffraction element, it rejects useless information, only useful information reaches the fiber end. Component 5, 6, 7, 8 and other components are encompassed as a module, digital and analog signals can be resulted by means of A/D and D/A converters and can be output through OUT I and OUT II respectively. Menu setting button 12 can ensures various extended functions supported by software.

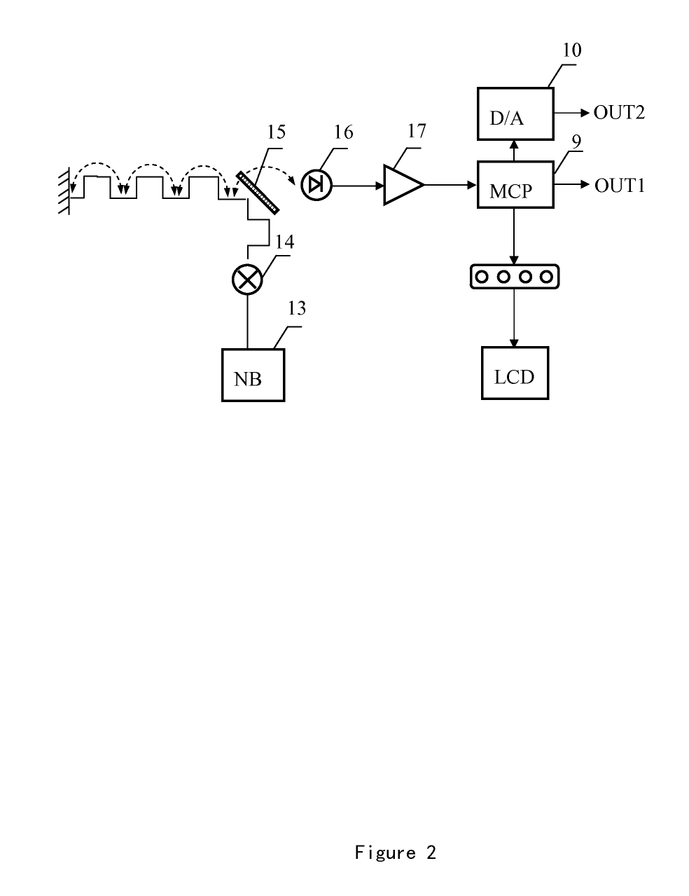

For low temperature measurement, another version of optical digital thermometer is designed, as illustrated in FIG. 2, where the quantum wave can be decelerated directly. With the oscillator 13, laser modulator 14, a beam with pulse interval B is launched through the semi-permeable mirror 15, it aims directly at the point of target, the temperature information is carried by the probe beam, which is detected and processed by photo detectors 16, amplifier 17, so that all quantums are lined up. This process is similar to taking pictures in a dark room, when flash light blinks, a quantum wave is launching, wherein the image information is carried and is sent back to camear. If all components are miniaturized, then the body temperature thermometer can be packed as small as a pen, which can be used to measure temperatures in various harsh environments in a convenient and accurate way. By comparison, The indirect deceleration technology makes use of charge-coupled device (CCD), logarithmic amplifier and analog to digital converter (A/D).

FIG. 3 further explains other applications of formulas (1) and (2): When the quantum waves superposition electromagnetic waves, known as information waves, the transmission speeds of γ and m are very high, but they are independent of energy distribution and speed. By taking advantage of this feature, we can produce a serious of low speed quantum waves to replace the information waves, so that mb=NB can be satisfied. Because the combining of various temperature scales and logarithmic functions can take many forms to implement lgT=NB the proposed rule of quantum and quantum energy measurement and distribution can find applications in the following fields:
a: accurate measurement of many physical signals;
b: realization of digital optics;
c: encryption and decryption in lineless communications, and quantum optical antenna;
d: promotion the commercialization of photonic computers.

Based on the invention, accurate temperature measurement has been implemented.

1. A method of non-contact optical digital thermometer, wherein the theoretical basis is the said rule of quantum and quantum energy measurement and distribution, or E=lgT=γh=mb=NB, that is, the length of quantum line can be used to measure the quantum energy, when T>0, n^{T=10}^{^{NB}}, the amplitude of B is determined by the resolution (response speed) of devices, when T is increased by n times, formula E=LgTn still holds true. Using the said invention, accurate temperature measurements can be achieved in the following approaches:
Indirect deceleration of quantum waves: energy carried by temperature related information waves output digital signals (code numbers) by charge-coupled device (CCD) or analogue signals by photo detector, which are then processed by logarithmic amplifier, and analog-digital (A/D) conversion device to convert to code number. Because the wave is formed by the calibration of standard source, so lgT=NB is satisfied.
Direct deceleration of quantum waves: quantum wave with spacing B is aligned to the information wave, so that information is carried on the known wave, temperature is thus determined by lgT=NB=mb.
Hybrid direct and indirect deceleration of quantum waves: let a quantum wave radiates from optical fiber to the wave detector, another fiber receive the decelerated digital signal and convert it to digital signals by photo detectors and followed by A/D converter.

2. A method of non-contact optical digital thermometer, in accordance with claim 1, wherein the said optical digital thermometers comprise a serious models with varying specifications, those thermometer are independent to temperature to be measured, material properties, and the measuring distance.

3. A method of non-contact optical digital thermometer, in accordance with claim 2, wherein the optical wave detector, or optical combiner is used, the measurement results are coincide with that of platinum-rhodium thermocouple, regardless of optical digital or electronic digital approaches, but the respond speed of said non-contact thermometer is much faster, it is expected to be upgraded as standard thermometer.

4. A method of non-contact optical digital thermometer, in accordance with claim 3, the standard calibration thermometer spossess precision 1-2 orders higher than the thermometer, because at the same temperature, the amplitude of a quantum is variable, in accordance with this rule, at the constant quantum line length, by changing the quantum state, the quantum number Increase or decrease the measurement precision of a thermometer is depend on the quantum number, therefore, based on the proposed formula of quantum energy distribution, tradition blackbody calibration equipments can be replaced by the present invention, and rapid calibration can be achieved.

5. A method of non-contact optical digital thermometer, in accordance with claim 4, wherein the said formula of quantum and quantum energy distribution can be used in other areas, such as high-precision multi-phase flow meter, because the number of quantum waves vary with the properties of fluids.

6. The said non-contact optical digital thermometer referred to as DT; the standard calibration thermometer is referred to as an etalon EDT, they all are essentially different from peer products.
